(19) United States
(12) Patent Application Publication
(10) Pub. No.: US 2002/0093895 A1
(43) Pub. Date: Jul. 18, 2002

(54) Optical disc, disc cartridge and optical disc drive

(76) Inventor: Kazuo Fujiura, Nishitokyo-shi (JP)

Correspondence Address: PILLSBURY WINTHROP, LLP, P.O. BOX 10500, MCLEAN, VA, 22102, US

(21) Appl. No.: 10/042,386

(22) Filed: Jan. 11, 2002

(30) Foreign Application Priority Data
Jan. 15, 2001 (JP) 2001-006858

(51) Int. Cl. G11B 7/00

(52) U.S. Cl. 369/53.2; 369/280; 369/282

(57) ABSTRACT

A recession is provided on the outer side of a data area of a disc, and this recession is provided so as to extend over a front side or a reverse side of the disc and a disc outer periphery end surface. By arranging one or more recessions on the front side or the reverse side, the front and reverse sides (side A/side B) of the disc or a type of the disc can be recognized.

### CROSS-REFERENCE TO RELATED APPLICATIONS

This application is based upon and claims the benefit of priority from the prior Japanese Patent Application No. 2001-006858, filed Jan. 15, 2001, the entire contents of which are incorporated herein by reference.

### BACKGROUND OF THE INVENTION

1. Field of the Invention

The present invention relates to an optical disc such as a CD or a DVD, and more particularly to a structure of an optical disc for judging a type or front and reverse sides of an optical disc by the tactual sensation.

2. Description of the Related Art

In these days, types of discs such as a CD-ROM, a CD-AUDIO, a CD-VIDEO, a CD-R, a CD-RW, a DVD-ROM, a DVD-RAM, a DVD-MOVIE, a DVD-R and a DVD-RW tend to increase, and this tendency is considered to continue in future.

In such optical discs, there are many discs having one surface as a recording side and the other surface as a non-recording side. Further, among DVD-RAMs, some have the bear disc on both sides on which information can be recorded/reproduced by a drive device. In case of such a DVD-RAM, the disc is reversed, and information can be recorded/reproduced on the side A and the side B.

In general, the recording side and the non-recording side are recognized by the visual judgment. Besides the visual judgment in order to recognize the side A and side B or the like, it can be considered that provision of tactual recognizing means is desirable when a blind handles the optical disc or the optical disc is handled in a dark place.

For example, Jpn. Pat, Appln. KOKAI Publication No. 249802/1996 discloses a technique which enables tactual and visual recognition of a disc. According to this prior art, a disc can be tactually and visually recognized by giving various kinds of physical characteristics to the disc outer peripheral portion.

In the above-described prior art, although a type or the front and reverse sides, e.g., the side A and the side B of a disc are recognized by the uniform cross-sectional shape on the disc outer peripheral end surface, there are not many cross-sectional shapes which are effective for recognition, and therefore there are not many types of the optical discs which can be recognized.

### BRIEF SUMMARY OF THE INVENTION

It is an object of the present invention to enable a user to tactually recognize front and reverse sides and/or a type of an information medium such as an optical disc.

According to an aspect of the present invention, an information storage medium comprising a disc-like shape substrate has a center hole and a peripheral side. The medium comprising: a data area configured to store or to record given information and being formed on the substrate; a clamp area located outside the center hole and inside the data area; and one or more notches or grooves. The one or more notches or grooves is/are provided on at least one of: a portion of the peripheral side, another portion of the center hole, and still another portion of the clamp area.

### BRIEF DESCRIPTION OF THE SEVERAL VIEWS OF THE DRAWING

FIGS. 1A to 1C are views showing the structure of an optical disc according to a first embodiment of the present invention;

FIGS. 2A and 2B are views showing the structure of an optical disc according to a second embodiment of the present invention;

FIGS. 3A and 3B are views showing the structure of an optical disc according to a third embodiment of the present invention;

FIGS. 4A and 4B are views showing the structure of an optical disc according to a fourth embodiment of the present invention;

FIGS. 5A to 5E are views showing the structure of an optical disc according to a fifth embodiment of the present invention;

FIG. 6 is a view showing the structure of an optical disc according to a sixth embodiment of the present invention;

FIG. 7 is a view showing the structure of an optical disc according to a seventh embodiment of the present invention;

FIGS. 8A to 8C are views showing the structure of an optical disc with a cartridge according to an eighth embodiment of the present invention;

FIGS. 9A and 9B are views showing the structure of an optical disc with a cartridge according to a ninth embodiment of the present invention;

FIG. 10 is a block diagram showing the structure of an optical disc drive (for both recording/reproduction) according an embodiment of the present invention;

FIG. 11A is a flowchart for illustrating disc judgment processing; and

FIG. 11B is a flowchart for illustrating copy management processing.

### DETAILED DESCRIPTION OF THE INVENTION

Embodiments according to the present invention will now be described in detail with reference to the accompanying drawings hereinafter.

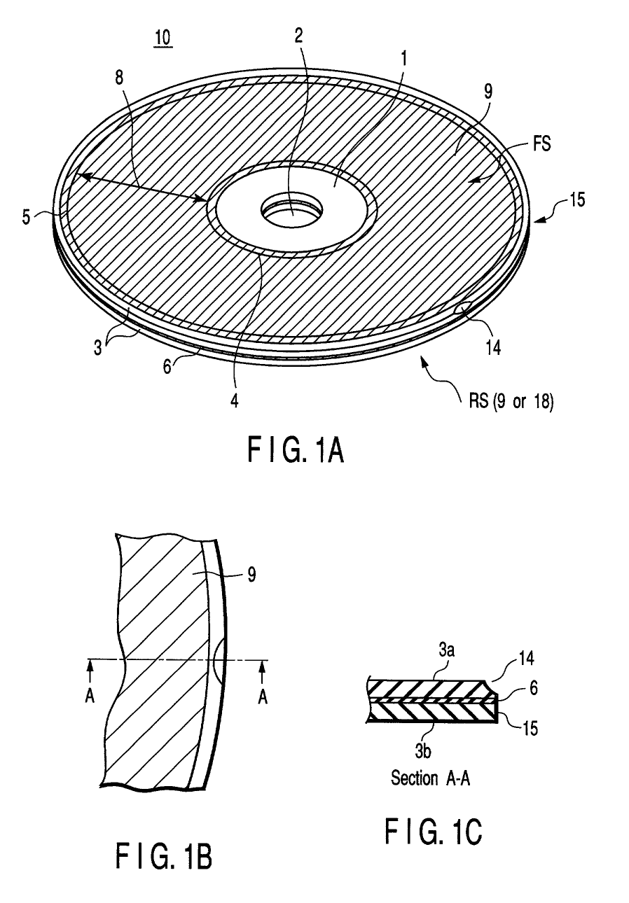

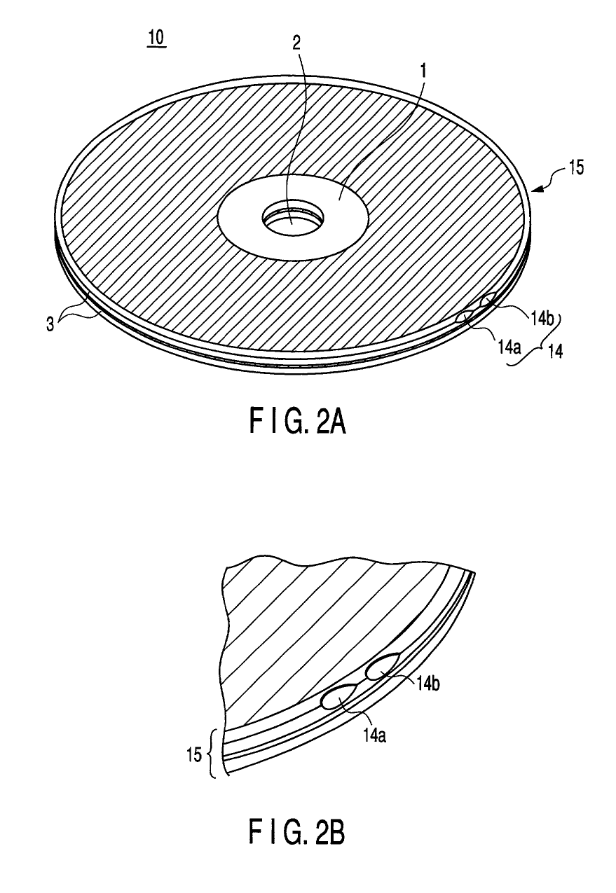

FIGS. 1A to 1C are views showing the structure of an optical disc such as a DVD according to a first embodiment of the present invention. A thickness of the disc is illustrated in an exaggerated form for the sake of explanation. FIG. 1A is a perspective view showing the entire disc 10, FIG. 1B is a partial view showing in the enlarged manner a part of a recession (a notch or a groove) 14 provided to the disc outer peripheral portion, and FIG. 1C is a cross-sectional view taken along the line A-A in FIG. 1B.

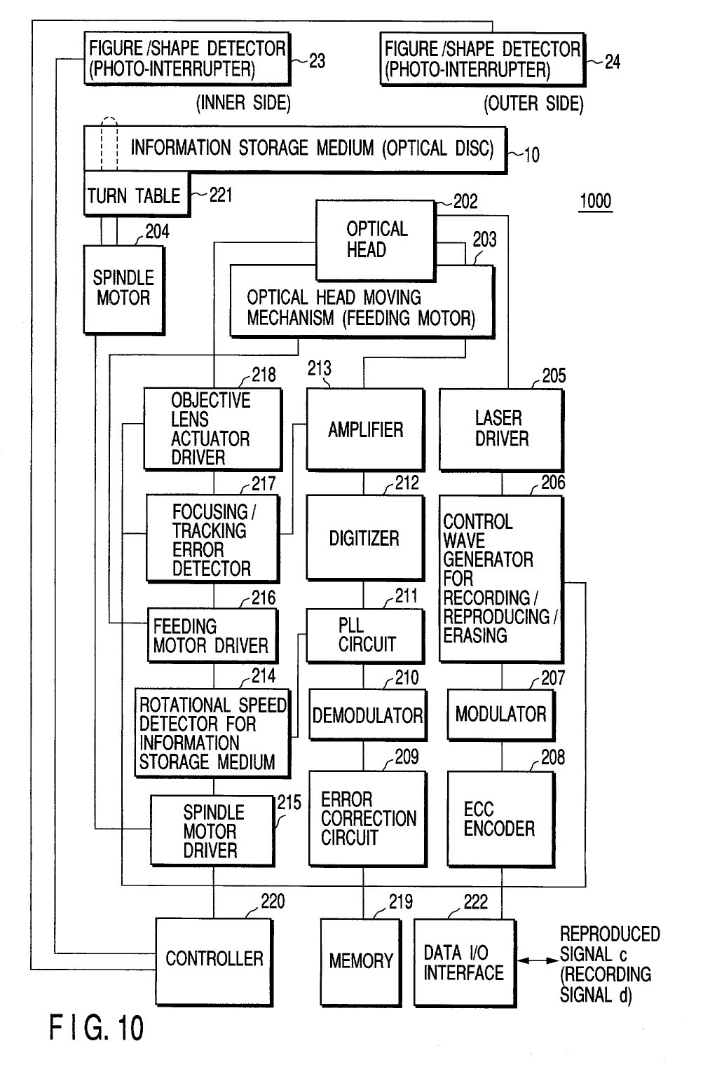

A center hole 2 is provided to the optical disc 10, and a clamp area 1 for clamping the optical disc 10 at the time of rotational drive is provided to the periphery of the center hole 2 on the both sides of the disc. When the optical disc 10 is attached to a later-described disc drive device which will be described later with reference to FIG. 10, a protrusion (non-illustrated conical spindle) at the center of a turn table attached to a spindle motor is inserted into the center hole 2. Then, the optical disc 10 is clamped by a non-illustrated disc damper in the clamp area 1 during rotation of the optical disc.

The optical disc 10 has a data area 9 in which video data, audio data, computer data and any other information can be recorded around the clamp area 1. In the data area 9, a read-in area 4 is provided on the inner peripheral side which comes into contact with the clamp area 1. Further, a read-out area 5 is provided on the outer peripheral side of the data area 9. Furthermore, an information recording area 8 is defined between the read-out area 5 and the read-in area 4.

The optical disc 10 shown in FIGS. 1A to 1C is an example that a gently spherically recessed portion (a notch or a groove) 14 is provided in the disc outer peripheral portion on the outer side of the data area 9 in the disc (for example, a DVD disc) obtained by attaching two substrates 3 (3a and 3b in FIG. 1C) through an adhesive layer 6. The recession 14 in this embodiment is formed at a corner edge on the disc outer peripheral end surface 15 of the disc 10. In other words, the recession 14 is provided so as to extend over both one (side A in this example) of a front side (side A) FS and a reverse side (side B) RS of the disc 10 and the disc outer peripheral end surface 15.

Incidentally, when the disc 10 is a double-sided disc, the data area 9 is provided on both the side A (front side FS) and the side B (reverse side RS). When the disc 10 is a single-sided disc, the data area is provided on the side A (FS), and the side B (RS) can be utilized as a label area 18.

When a user of the disc 10 holds the disc 10 and applies a finger (not shown) to the corner edge of the outer peripheral portion 15 while rotating the disc 10, he/she can be tactually aware of a type (whether it is a DVD-ROM or a DVD-R, for example) or the side A/side B of this disc 10. Since the outer peripheral portion 15 is a part which can be touched by a hand when handling the disc 10, the recession 14 can be easily recognized. If a quantity of dimple of the recession 14 is approximately 0.5 mm, it can be sufficiently tactually recognized, and the recession 14 can be provided without invading the existing data area 9.

A method for providing the recession 14 at the disc outer peripheral portion 15 on the outer side of the data area 9 can be performed while satisfying existing standards (standards for the DVD or CD). Therefore, any special disc loading device (or any special disc clamp device) is not required due to provision of the recession 14.

Moreover, since the surface of the recession 14 is a surface which is smoothly connected to the outer peripheral portion of the disc 10, noises (for example, whizzing sound) caused due to provision of the recession 14 hardly occur during high-speed rotation of the disc.

In this embodiment, the cross section of the recession portion 14 is as shown in FIG. 1C. The recession 14 is provided on one side (the front side FS or the side A) of the laminated disc 10. That is, the recession 14 is provided to the outer peripheral portion of one (3a) of the two disc substrates (3a and 3b) attached to each other.

Whether the recession 14 concerns information about the disc substrate 3a or information about the disc substrate 3b is not restricted here. The recession 14 can be used as information concerning the disc substrate 3a or also used as information concerning the disc substrate 3b. In addition, the surface on which the recession 14 is provided may be determined as a label surface (non-recording side) 18 of the single-sided recording disc, and this single-sided recording disc may be set in a non-illustrated disc drive.

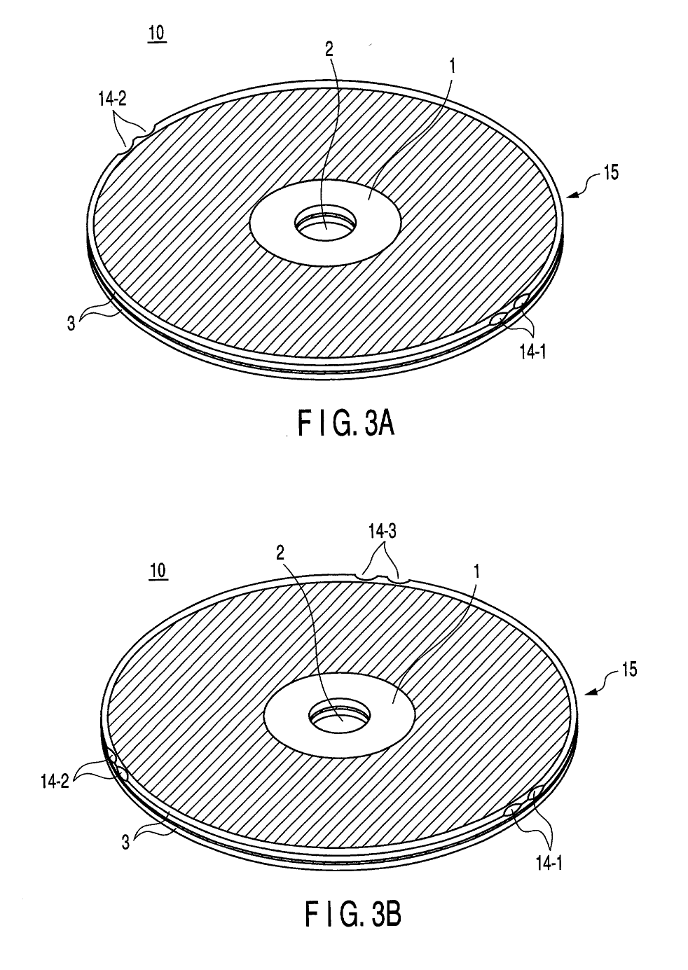

FIG. 2A is a view showing the structure of an optical disc according to a second embodiment of the present invention and illustrates an example in which two recessions 14 (14a and 14b) are continuously provided. These recessions 14a and 14b are continuously provided at a part of the outer peripheral end surface 15 of the disc 10. FIG. 2B is an enlarged view showing the recession portion. The recessions 14a and 14b are arranged in contiguity with each other so that both the recessions 14a and 14b can be recognized without moving a fingertip when the fingertip of a user comes into contact with these parts.

FIGS. 3A and 3B are views showing the structure of an optical disc according to a third embodiment of the present invention. Here, a plurality of recession portions are provided at symmetrical positions on the outer peripheral end surface 15 of the optical disc 10. FIG. 3A shows an example in which recession portions 14-1 and 14-2 are arranged at positions which are symmetrical to each other 180 degrees with the center hole 2 of the disc 10 at the center. With this symmetrical arrangement, it is possible to obtain the advantage to reduce unbalance (off dynamic balance) of the disc 10 and suppress occurrence of rampage (vibration) and/or side-runout of the disc 10 at high-speed rotation. In addition, increasing a number of positions at which the recession portions are arranged can lead do rapid recognition of a type of the disc 10 or the like.

FIG. 3B shows an example that the recession portions 14-1 to 14-3 are arranged at three positions every 120 degrees. Here, two recessions 14 are provided to each of the recession portions 14-1 to 14-3. A number of positions at which the recession portions are arranged can be increased above three (for example, four positions every 90 degrees). When a number of positions at which the recession portions are arranged is increased too much, however, the recessions 14 are continuously arranged on the entire outer peripheral portion of the disc 10. In such a case, it is hard to use a number of the recessions 14 which are continuously arranged in contiguity with each other as a subject matter for judging a type of the disc, and a merit derived from provision of many recessions 14 is lost. Thus, an appropriate layout (FIG. 3A or 3B) is desirable for arrangement of a plurality of the recession portions.

A number of types of the recognizable discs can be increased by combining the shape/type and a number of the recessions 14 to be arranged. Additionally, when adding the recessions 14 to the disc 10, there is employed the structure that the side-runout and/or increase in the vibration noise of the disc substrates during high-speed rotation is suppressed by adopting the smooth surface structure and arrangement of the symmetrical positions.

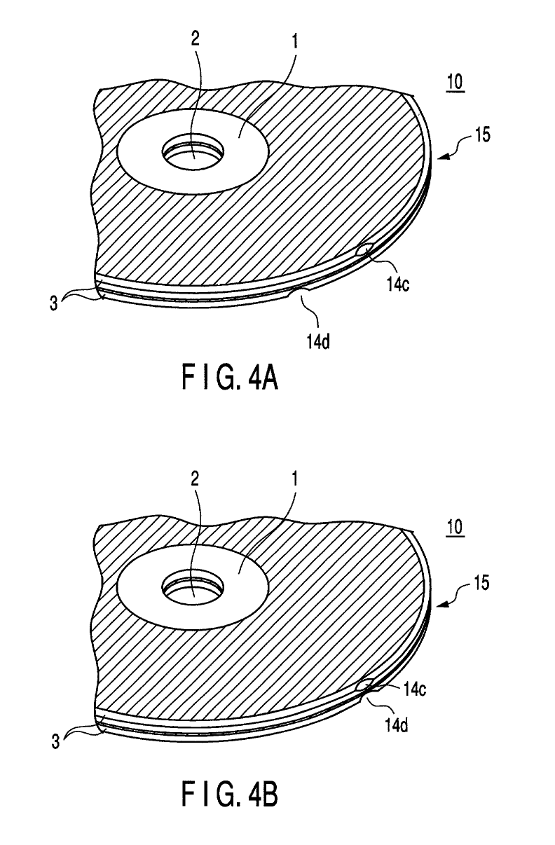

FIG. 4A is a view showing the structure of an optical disc according to a fourth embodiment of the present invention and illustrates an example in which a different number of the recessions 14c and 14d are staggered and arranged on the side A and side B. When one recession 14c is arranged on the side A and two recessions 14d are continuously arranged on the side B in this manner for example, a user can recognize the side A and the side B from the tactile sense of the fingertip. Alternatively, when the recession 14c on the side A and the recession 14d on the side B have the shapes/sizes different from each other, a user can recognize the side A and the side B from the tactile sense of the fingertip even if a number of recessions differ depending on the side A and the side B.

FIG. 4B shows an example that the recession 14c on the side A and the recession 14d on the side B are arranged on the same position. In this case, the disc edge becomes a sharp edge only at the recession portions on the both sides which are arranged on the same position or the disc strength becomes weak only at that position in some cases. In such a case, it is desirable to adopt the structure in which the positions of the recessions are staggered between the side A and the side B.

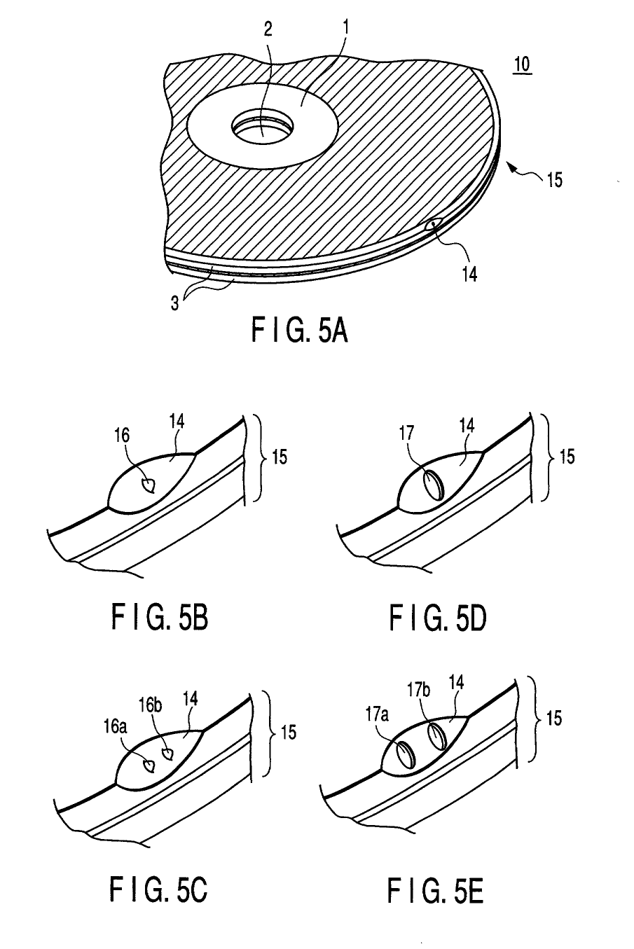

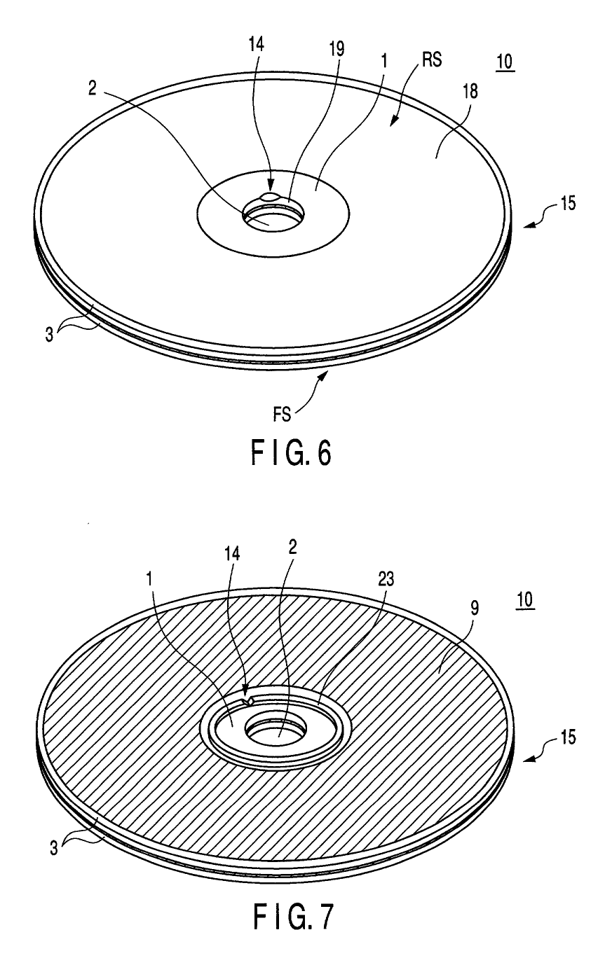

FIG. 5A is a view showing the structure of an optical disc according to a fifth embodiment of the present invention, in which a small protrusion is provided to the recession 14 to function as recognizing means. FIGS. 5B to 5E are views showing the part of the recession 14 illustrated in FIG. 5A in the enlarged manner. FIG. 5B shows an example that a small protrusion 16 is provided so as not to protrude from the disc outside shape. FIG. 5C shows an example that two such protrusions 16 are provided. FIG. 5D shows an example that a small rib (or a dimple: slot or opening) 17 is arranged in the recession 14. FIG. 5E illustrates an example that two such ribs (or dimples) are provided.

FIG. 6 is a view showing the structure of an optical disc according to a sixth embodiment of the present invention and illustrates an example that the recession 14 is arranged on the disc inner peripheral end surface 19. Reference numeral 18 denotes a non-recording surface (or the reverse side RS). In general, a conical spindle (not shown) of a turn table is inserted into the center hole 2 from the recording side (or the front side FS) of the disc 10, and a rotational center of the optical disc is determined by the side surface of the conical spindle and the inner wall surface of the center hole 2. Therefore, on the disc inner peripheral end surface 19, when the edge portion of the substrate 3 on the recording side (FS) is machined for the recession 14, the center of the disc may deviate from the center of the spindle in some cases. Thus, the recession 14 shown in FIG. 6 is provided on the substrate 3 on the non-recording side (RS) 18 of the single-sided optical disc 10 having the recording side only on one surface (FS) of the disc.

FIG. 7 is a view showing the structure of an optical disc according to a seventh embodiment of the present invention, in which a stack ring 23 is provided at a position which does not come into contact with the non-illustrated disc damper in the clamp area 1 of the disc 10. Further, in this example, the recession 14 is provided at a part of the stack ring 23. In general, a ring-like convex portion is provided in the clamp area 1 on the recording side 9 of the optical disc 10 in order to protect the recording side 9, and this is called a stack ring. In the optical disc 10 according to this embodiment, the recession 14 is provided to this stack ring 23. The recession 14 is not restricted to one position, and a plurality of the recessions 14 may be provided at multiple positions on the stack ring 23. As similar to the embodiments shown in FIGS. 1 to 6, a type of the disc 10 can be judged based on a shape, a structure and/or a number of the (one or more) recessions 14.

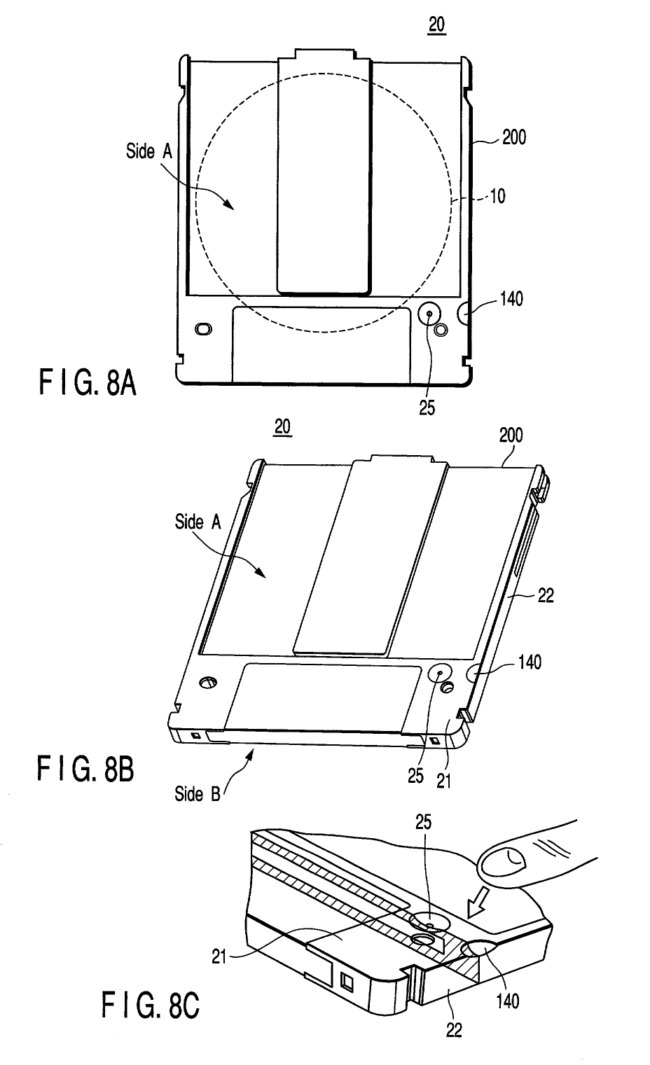

FIG. 8A is a plane view showing the structure of an optical disc according to an eighth embodiment of the present invention, FIG. 8B is a perspective view of the same, and FIG. 8C is a partial enlarged perspective view (shaded area shows a cross section) of the same. This embodiment is an example that the recession portion 140 having the gentle spherical surface is provided at the outer peripheral portion of a disc case 200 used for the cartridge 20 for a DVD-RAM disc 10. This recession 140 is provided so as to extend both one side 21 and an end surface 22 of the case 200 of the disc cartridge 20. In other words, the recession 140 is formed at a part of the corner edge of the case 200 of the disc cartridge 20.

It is to be noted that a mark (irregularities having different shapes or numbers depending on the side A and the side B) indicating the side A and/or the side B can be provided at a position which is a part of the surface (side A surface and/or side B surface) of the case 200 and is adjacent to the recession 140. It is possible to recognize the side A or the side B by using this mark 25 from the tactile sense of the fingertip.

Furthermore, it is possible to recognize a type of the disc 10 (whether it is a single-sided disc or a double-sided disc, or 2.6 giga bytes on one side or 4.7 giga bytes on one side, for example) in the case 200 by using the recession 140 in the vicinity of the mark 25 from the tactile sense of the fingertip.

In this embodiment, since the mark 25 and the recession 140 are formed at positions close to each other, a user can touch the mark 25 and the recession 140 without moving the fingertip.

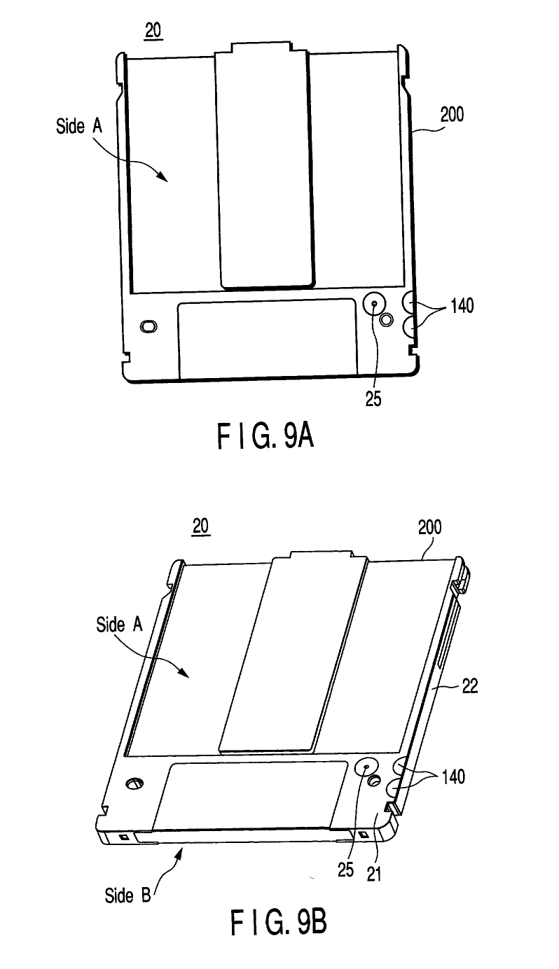

FIG. 9A is a plane view showing the structure of an optical disc according to an eight embodiment of the present invention, and FIG. 9B is a perspective view of the same. This embodiment is an example that two recession portions 140 having the gentle spherical surfaces are provided at the outer peripheral portion of the disc case 200 used for the cartridge 20 for the DVD-RAM disc 10. Each recession 140 can be configured as similar to the recession 140 shown in FIGS. 8A to 8C.

Incidentally, although the above has descried the case where the recession 14 (or 140) is detected by the tactile sense of the fingertip of a user, the shape/structural characteristic with which visual distinction/recognition is enabled can be given to the recession 14 (or 140). Therefore, the disc 10 can be recognized by utilizing the recession 14 (or 140) from the tactile sense as well as the visual sense.

By combining types and/or a number of various recessions 14 (or 140) described in the embodiments shown in FIGS. 1 to 9 (or further combining the mark 25 shown in FIGS. 8 to 9 with the recessions 14/140), it is possible to tactually or visually recognize:

(1) a disc type such as a CD-ROM, a CD-AUDIO, a CD-VIDEO, a CD-R, a CD-RW, a DVD-ROM, a DVD-RAM, a DVD-MOVIE, a DVD-R and a DVD-RW;

(2) front and reverse sides of the disc;

(3) types of contents of the disc (movie, sports, music and others); and

(4) a version of the disc (a transfer rate, a rotation speed, whether CLV is supported, namely, performances of the disc and others).

For example, in case of a double-sided disc on which information can be recorded and reproduced as typified by a DVD-RAM, it is possible to define that the surface on which the recession 14 is solely arranged at the outer peripheral portion of the disc 10 indicates the side A, the surface on which two recessions 14 are continuously arranged indicates the side B, and the surface on which three recession 14 are continuously arranged is a non-significant surface (that is, this is the non-recording surface on which no information can be recorded and reproduced, i.e., the label surface when the disc is a single-sided disc). As a result, a user can be visually as well as tactually (based on the tactile sense of the fingertip even in the dark) aware of which surface is used to perform recording (or reproduction).

Furthermore, it is possible to define that a disc having no protrusion in the recession 14 is a ROM type disc such as a CD-ROM or DVD-ROM, a disc having one protrusion 16 (or 17) arranged is a DVD-RAM disc and a disc having two protrusions 16 (or 17) arranged is a DVD-R, for example. Therefore, a user can visually and tactually recognize which disc is a rewritable disc.

In this manner, it is possible to visually/tactually recognize a type of the disc that a user is going to use or which one of the side A/side B is the top surface based on a combination of a number of the recessions 14 (or 140) provided at the outer peripheral portion or the inner peripheral portion of the disc or detailed information (shape/structure) in the recessions 14 (or 140). Moreover, since many combinations of a number and the shape/structure of the recessions 14 (or 140) can be considered, the recessions 14 (or 140) can be effectively used even if a number of types of the discs will be increased in future. It is to be noted that this combination is not restricted to the above-described combination.

Description will now be given as to an optical disc drive which records and reproduces information on the optical disc 10 having the above-described recessions 14 (or 140). FIG. 10 is a block diagram showing the structure of an optical disc drive 1000 according to an embodiment of the present invention.

This optical disc drive 1000 records or rewrites (including erasing information) new information by using a condensing spot at a predetermined position on the optical disc 10. Moreover, this optical disc drive 1000 reproduces the information which has been already recorded by using the condensing spot from a predetermined position on the optical disc.

As means for attaining functions for rewriting (erasing) and reproducing information, the optical disc drive 1000 traces the condensing spot along a track (n shown) on the optical disc 10. In addition, switching of recording/reproducing/erasing of information is carried out by changing the light intensity of the condensing spot which is emitted onto the optical disc 10. Additionally, a recording signal d given from the outside is converted into a signal which is optimum for recording with the high density and the low error rate.

The structure of the mechanism portion and the operation of a detection portion will be first described.

An optical head 202 is constituted by a semiconductor laser element (not shown) which is basically a light source, a light detector and an objective lens.

The leaser beam emitted from the semiconductor laser element is converged on the optical disc 10 by the objective lens. The leaser beam reflected on a light reflection film or a light reflective recording film of the optical disc 10 is subjected to photoelectric conversion by the light detector.

A detection electric current obtained by the light detector is subjected to electric current-voltage conversion by an amplifier 213 and becomes a detection signal. This detection signal is processed in a focusing/tracking error detector 217 or a binarization circuit 212. In general, the light detector is divided into a plurality of light detection areas and they individually detect a change in the light intensity with which each light detection area is irradiated. The focusing/tracking error detector 217 carries out the arithmetic operation to obtain a sum or a difference with respect to the respective detection signals, and detection of a focusing error and a tracking error is performed. Then, a change in a quantity of the reflected light from the light reflection film or the light reflective recording film of the optical disc 10 is detected, and the signal on the optical disc is reproduced.

The objective lens (not shown) which condenses the leaser beam emitted from the semiconductor laser element on the optical disc 10 has the structure capable of moving in the two axial directions in accordance with an output electric current of an objective lens actuator driver 218. As to the moving directions of the objective lens, the objective lens moves in a direction vertical to the optical disc 10 in order to correct the focusing error, and moves in the radial direction of the optical disc 10 in order to correct the tracking error. Although not shown, the mechanism for moving the objective lens is called an objective lens actuator.

The optical disc 10 is attached on the turn table which rotates by the drive force of a spindle motor 204.

A number of revolutions of the optical disc 10 is detected by a reproduction signal obtained from the optical disc 10. That is, the detection signal (analog signal) outputted from the amplifier 213 is converted into a digital signal by a binarization circuit 212, and a constant cycle signal (reference clock signal) is generated from this signal by a PLL circuit 211. An optical disc rotational speed detector 214 detects a number of revolutions of the optical disc 10 by using this signal and outputs its value.

The correspondence table showing a radial position at which “reproduction or recording/erasing” is carried out in the optical disc 10 and a number of revolutions of the optical disc is recorded in a semiconductor memory 219 in advance. When a reproduction position or a recording/erasing position is determined, a control portion 220 sets a target number of revolutions of the optical disc 10 by making reference to information in the semiconductor memory 219, and informs a spindle motor driver 215 of its value.

The spindle motor driver 215 obtains a difference between this target number of revolutions and an output signal (number of revolutions in the actual status) of the optical disc rotational speed detector 214, and gives a drive electric current according to its result to the spindle motor 204. Then, the spindle motor driver 215 controls in such a manner that a number of revolutions of the spindle motor 204 becomes a fixed value according to the target number of revolutions. The output signal of the optical disc rotational speed detector 214 is a pulse signal having a frequency according to a number of revolutions of the optical disc 10, and the spindle motor driver 215 controls both a frequency and a pulse position of this signal.

An optical head moving mechanism (feeding motor) 203 is provided to the optical disc drive 1000 in order to move the optical head 202 in the radial direction of the optical disc 10.

As a guide mechanism for moving the optical head 202, a rod type guide shaft (not shown) is in heavy usage. The optical head 202 moves by utilizing the friction between the guide shaft and a bush (not shown) disposed to a part of the optical head 202. Besides, there is a method using a bearing by which the rotational movement is used and the frictional force is reduced.

As a drive force transmitting method for moving the optical head 202, although not shown, there is the following method. That is, a rotary motor having a pinion (rotating gear) is arranged in a fixed system, and a rack having a linear gear which engages with the pinion is arranged on the side surface of the optical head 202. Then, the rotational movement of the rotary motor is converted into the linear motion of the optical head 202 by a combination of the linear gear and the pinion. As another drive force transmitting method, there is also a case using a linear motor system which arranges a permanent magnet in a non-illustrated fixed system, flows an electric current to a non-illustrated coil arranged to the optical head 202 and moves the optical head 202 in the linear direction.

In both the rotary motor system and the linear motor system, basically, an electric current is caused to flow to the feeding motor, and the drive force for moving the optical head 202 is generated. This drive electric current is supplied from a feeding motor driver 216.

The function of each control circuit will now be described.

A circuit which supplies the drive electric current to the objective lens actuator (not shown) in is the optical head 202 in accordance with the output signal (detection signal) of the focusing/tracking error detector 217 in order to correct a focusing error or a tracking error is an objective lens actuator driver 218. In order to realize the high-speed response of the object lens movement to a high frequency domain, the driver 218 includes a phase compensator for characteristic improvement which is adapted for the frequency characteristic of the objective lens actuator.

In accordance with a command from the control portion 220, the objective lens actuator driver 218 carries out:

ON/OFF processing for the focusing/tracking error correction operation (focusing/tracking servo loop);

processing for moving the objective lens to the vertical direction (focusing direction) of the optical disc 10 at a low speed (executed when the focusing/tracking servo loop is OFF); and

processing for moving the condensing spot to an adjacent track by slightly moving in the radial direction (direction cutting across the track) of the optical disc 10 by using a kick pulse, or the like.

The laser beam intensity control will now be described. The light intensity of the laser beam at the time of reproduction and recording/erasing is switched by changing the light intensity of the condensing spot projected on the optical disc 10.

Generally, the following relationship can be attained with respect to the optical disc (for example, a DVD-RAM disc) 10 using the phase change system:

[light intensity for recording]>[light intensity for erasing]>[light intensity for reproducing] Further, the following relationship is generally achieved with respect to the optical disc using the magnetic optical system:

[light intensity for recording≈[light intensity for erasing]>[light intensity for reproducing] In case of the magnetic optical system, recording and erasing processing is controlled by changing the polarity of an external magnetic field (not shown) added to the optical disc 10 at the time of recording/erasing.

When reproducing information, the optical disc 10 is continuously irradiated with the fixed light intensity.

In case of recording new information, the pulse-like intermittent light intensity is added to the light intensity at the time of reproduction. When the semiconductor laser element performs the pulse light emission with the large light intensity, the light reflective recording film of the optical disc 10 is locally optically changed, or the shape of this film is locally changed, thereby forming a recording mark. In case of overwriting on the area in which information has been already recorded, the semiconductor laser element is similarly caused to perform pulse light emission.

In case of erasing the already recorded information, the fixed light intensity which is larger than that at the time of reproduction is continuously projected. In case of continuously erasing information, the light intensity to be projected is returned to the light intensity for reproduction every specific cycle, for example, units of sector, and information is intermittently reproduced concurrently with the erasing processing. Then, a track number or an address of the track from which information is intermittently erased is reproduced, and the erasing processing is conducted while confirming that there is no error in the track which is a target of erasing.

Although not shown, a light detector which detects a quantity of light emission of the semiconductor laser element is included in the optical head 202. The semiconductor laser driver 205 obtains a difference between an output from the light detector (detection signal indicative of a quantity of light emission of the semiconductor laser element) and a light emission reference signal given from a control wave generator so for recording/reproducing/erasing 206, and feeds back the drive electric current to the semiconductor laser based on its result.

The optical disc drive 1000 according to an embodiment of the present invention has figure/shape detectors 23 and 24 used for judging front and reverse sides (side A/side B) and a type (whether it is a DVD-RAM, a DVD-RW, a DVD-R, a DVD-ROM or the like) of the optical disc 10 inserted into the drive 1000. The figure/shape detector 23 detects the recession 14 provided on such a disc inner peripheral side 19 as shown in FIG. 6, and discriminates the front and reverse sides of the optical disc 10. The figure/shape detector 24 detects the recession 14 provided to such a disc outer peripheral side 15 as shown in FIGS. 1 to 5 or the recession 140 (or the mark 25) provided to such a disc cartridge 20 as shown in FIGS. 8 and 9, and discriminates the front and reverse sides or a type of the disc.

The figure/shape detector 24 (and/or 23) can be configured as follows, for example. That is, although not shown, the figure/shape detector 24 (and/or 23) is constituted by a light emitting diode, a light guiding portion which directs the light from this light emitting diode to a position at which the recession 14 (or 140) exists, and a photodiode which accepts the light reflected on the recession 14 (or 140). The light from the light emitting diode is configured/adjusted so as to be reflected at a part on the disc end surface 15 (or 19) where the recession 14 (or 140) exists and returned to the photodiode.

When there is no recession 14 (or 140) at a part on which the light from the light emitting diode should be projected, the reflecting light path from the light emitting diode to the photodiode is interrupted (the direction of the reflected light is changed, and the reflected light does return to the photodiode). This interruption becomes a change in an output electric current of the photodiode. Therefore, presence/absence of the recession 14 (or 140) can be detected from a change in the output electric current of the photodiode.

Furthermore, a change in the light intensity which returns to the photodiode differs depending on the shape/structure of the recession (whether the recession 14 consists of a simple concave curved surface as in the example of FIG. 1C or whether the recession 14 includes a plurality of the protrusions 16, the rib 19 or the like as in the example shown in FIGS. 5B to 5E). Based on this difference, the recessions 14 having the different shapes/structures as shown in FIGS. 5B to 5E can be discriminated, for example.

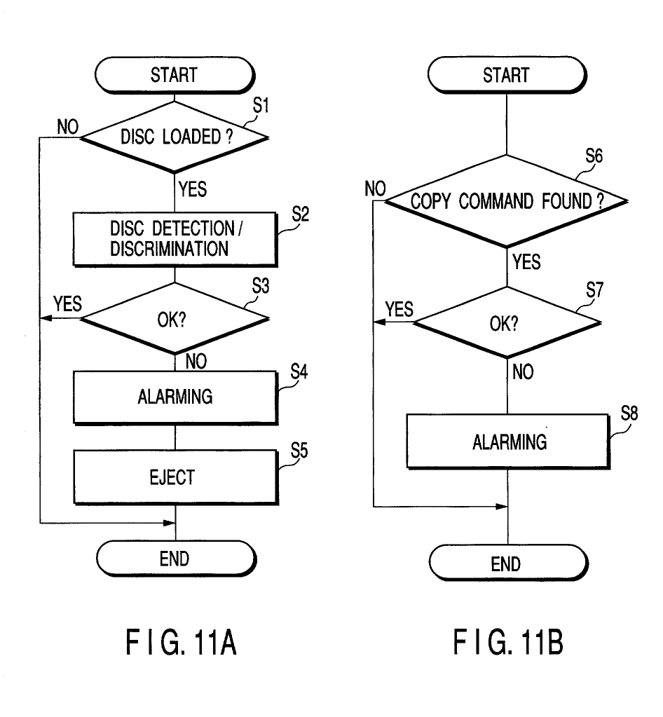

FIG. 11A is a flowchart for illustrating judgment processing using the recession 14 (or 140). When the optical disc 10 is inserted into the drive 1000 (Yes in step S1), the inserted disc 10 is clamped on the turn table 221, and the start-up control is commenced. Then, the front and reverse sides and a type of the disc is judged.

That is, the control portion 220 shown in FIG. 10 uses the figure/shape detector 24 (and/or 23) to judge a type, the front and reverse sides or the like of the disc 10 from the recession 14 provided to the disc 10 or the recession 140 provided to the cartridge 20 (step S2).

When a type, the front and reverse sides or the like of the disc 10 is correctly judged by this discrimination processing (Yes in step S3), processing shown in FIG. 11A is completed.

When a type, the front and reverse sides or the like of the disc 10 is not correctly judged by this judgment processing, for example, when the disc 10 has a recording surface on only one side and the recording surface does not face downwards (optical head 202 side in FIG. 10) (No in step S3), the control portion 220 warns a user about this fact (step S4), and ejects the disc 10 (step S5).

Moreover, in the processing shown in FIG. 11B, when a copy command with respect to the disc 10 is issued (Yes in step S6), the control portion 220 makes judgment upon whether the disc 10 can be copied based on a result of judgment in the step S2 shown in FIG. 11A (step S7). When the disc 10 loaded in the drive 1000 is a disc exclusively used for reproduction such as a DVD-ROM or a CD-ROM (No in step S7), information can not be written on the disc 10, and the control portion 220 informs a user of this fact (step S8).

Conceivably, even if the disc 10 loaded in the drive 1000 is an unused new DVD-RAM but information to be copied has a flag for prohibiting copy (No in step S7), information can not be likewise written on the disc 10, and the control portion 220 informs a user of this fact (step S8).

The basic operation concerning the control system in the mechanism portion will now be described.

When the disc loaded in the optical disc drive is a disc suitable for this optical disc drive and the recording surface faces downwards (optical head 202 side), the following processing is carried out.

1) The control portion 220 informs the spindle motor driver 215 of a target number of revolutions, the drive electric current is supplied from the spindle motor driver 215 to the spindle motor 204, and rotation of the spindle motor 204 starts.

2) At the same time, a command (execution command) is issued from the control portion 220 to the feeding motor driver 216, the drive electric current is supplied from the feeding motor driver 216 to the optical head drive mechanism (feeding motor) 203, and the optical head 202 moves to the innermost peripheral position of the optical disc 10. The fact that the optical head 202 has moved beyond an area in which information of the optical disc 10 is written and reached the inner peripheral portion is confirmed.

3) When the spindle motor 204 has reached the target number of revolutions, that status (status report) is outputted to the control portion 220.

4) The electric current is supplied from the semiconductor laser driver 205 to the semiconductor laser element in the optical head 202 in accordance with the reproduction light intensity signal transmitted from the control portion 220 to the control wave generator for recording/reproducing/erasing 206, and the laser light mission is started. It is to be noted that the optimum irradiation light intensity for reproduction differs depending on a type of the optical disc 10. At the time of start-up, the irradiation light intensity is set to a lowest value.

5) The objective lens (not shown) in the optical head 202 is moved to a farthest position from the optical disc 10 in accordance with a command from the control portion 220, and the objective lens actuator driver 218 controls in such a manner that the objective lens slowly moves toward the optical disc 10.

6) At the same time, a quantity of the focusing error is monitored by the focusing/tracking error detector 217, the status is outputted when the objective lens has moved to the vicinity of a position at which focusing is achieved, and the control portion 220 is informed of this status.

7) When the control portion 220 receives this information, it issues a command to the objective lens actuator driver 218 in order to turn ON the focusing servo loop.

8) The control portion 220 issues a command to the feeding motor driver 216 while keeping the focusing servo loop in the ON state, and the optical head 202 is slowly moved to the outer peripheral direction of the optical disc 10.

9) At the same time, the reproduction signal from the optical head 202 is monitored, and movement of the optical head 202 is stopped when the optical head 202 has reached the recording area on the optical disc 10. Also, a command for turning ON the tracking servo loop is issued to the objective lens actuator driver 218.

10) The “optimum light intensity for reproduction” and the “optimum light intensity for recording/erasing” recorded at the inner peripheral portion of the optical disc 10 are reproduced, and this information is recorded in the semiconductor memory 219 through the control portion 220.

11) In addition, the control portion 220 transmits a signal according to the “optimum light intensity for reproduction” to the control wave generator for recording/reproducing/erasing 206, and resets a quantity of light emission of the semiconductor laser element for reproduction.

12) A quantity of light emission of the semiconductor laser element for recording/erasing is set in accordance with the “optimum light intensity for recording/erasing” recorded on the optical disc 10.

The access control will now be described.

Information indicating what kind of content is recorded where on the optical disc 10 differs depending on a type of the optical disc 10. This information is generally recorded in a directory management area (it is collectively recorded in the inner peripheral area or the outer peripheral area of the optical disc 10) in the optical disc 10 or a navigation pack (data pack which is included in a Video Object Set comply with the data structure of a Program Stream of MPEG2 and in which information indicative of which area a next image is recorded is contained) or the like.

In case of reproducing or recording/erasing specific information, the information in the above-described area is first reproduced, and a destination of access is determined based on the obtained information.

The control portion 220 calculates a radial position of the access destination and obtains a distance between the current position of the optical head 202 and the radial position.

Speed curve information indicative of the moving distance of the optical head 202 which can be achieved in the shortest time is recorded in the semiconductor memory 219 in advance. The control portion 220 reads that information, and executes the movement control over the optical head 202 in accordance with that speed curve by the following method.

That is, the control portion 220 issues a command to the objective lens actuator driver 218 and turns OFF the tracking servo loop. Thereafter, it controls the feeding motor driver 216 and starts movement of the optical head 202.

When the condensing spot cuts across the track on the optical disc 10, a tracking error detection signal is generated in the focusing/tracking error detector 217. A relative speed of the condensing spot with respect to the optical disc 10 can be detected by using this tracking error detection signal.

The feeding motor driver 216 calculates a difference between a relative speed of the condensing spot obtained by the focusing/tracking error detector 217 and target speed information fully transmitted from the control portion 220, and moves the optical head 202 while feeding back a result of calculation to the drive electric current for the optical head drive mechanism (feeding motor) 203.

As described above, the frictional force constantly acts between the non-illustrated guide shaft and the bush or the bearing. When the optical head 202 moves at a high speed, the kinetic friction acts. However, at the start of movement and immediately before stop of movement, the static friction acts since the movement speed of the optical head 202 is slow. At this moment (immediately before stop of movement in particular), since the frictional force is relatively increased, the gain of the electric current supplied to the optical head drive mechanism (feeding motor) 203 is increased in accordance with a command from the control portion 220.

When the optical head 202 has reached a target position, the control portion 220 issues a command to the objective lens actuator driver 218 in order to turn ON the tracking servo loop.

The condensing spot traces along the track on the optical disc 10, while an address or a track number at that part is reproduced.

A current condensing spot position is obtained based on the address or the track number at that part, and a number of error tracks from the attained target position is calculated in the control portion 220. Then a number of tracks required for movement of the condensing spot is informed to the objective lens actuator driver 218.

When a pair of kick pulses are generated in the objective lens actuator driver 218, the objective lens slightly moves in the radial direction of the optical disc 10, and the condensing spot moves to an adjacent track.

The tracking servo loop is temporarily turned OFF in the objective lens actuator driver 218, and kick pulses whose number is adapted to the information from the control portion 220 are generated. Thereafter, the tracking servo loop is again turned ON.

After completion of dense access, the control portion 220 reproduces the information (the address or the track number) of the position that the condensing spot is tracing, and confirms that access is made to a target track.

The continuous recording/reproducing/erasing control will now be described.

As shown in FIG. 10, the tracking error detection signal outputted from the focusing/tracking error detector 217 is inputted to the feeding motor driver 216. At the time of “start-up control” and “access control” mentioned above, the control portion 220 controls in such a manner the tracking error detection signal is not used in the feeding motor driver 216.

After confirming that the condensing spot has reached the target track from access, a part of the tracking error detection signal is supplied as the drive electric current to the optical head drive mechanism (feeding motor) 203 through the motor driver 216 based on a command from the control portion 220. During continuous execution of reproduction or recording/erasing processing, this control continues.

The optical disc 10 is attached with its central position slightly eccentrically deviating from the central position of the turn table 221. When a part of the tracking error detection signal is supplied as the drive electric current, the entire optical head 202 quivers in accordance with eccentricity.

Further, when the reproduction or recording/erasing processing is continuously carried out for a long time, the condensing spot position gradually moves in the outer peripheral direction or the inner peripheral direction. When a part of the tracking error detection signal is supplied as the drive electric current to the optical head moving mechanism (feeding motor) 203, the optical head 202 gradually moves in the outer peripheral direction or the inner peripheral direction in accordance with this supply.

In this manner, the burden of the tracking error correction by the objective lens actuator is reduced, and the tracking servo loop can be stabilized.

Upon completion of a series of processing, the processing is carried out in accordance with the following procedure in order to terminate the operation.

1) The control portion 220 issues to the objective lens actuator driver 218 a command to turn OFF the tracking servo loop.

2) The control portion 220 issues to the objective lens actuator driver 218 a command to turn OFF the focusing servo loop.

3) The control portion 220 issues to the control wave generator for recording/reproducing/erasing 206 a command to stop light emission by the semiconductor laser element.

4) Zero as a reference rotational number is informed to the spindle motor driver 205.

According to the optical disc of the present invention, front and reverse sides of an optical disc or many types of optical discs can be tactually recognized with the simple structure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An information storage medium comprising a disc-like shape substrate having a center hole and a peripheral side, said medium comprising:
a data area configured to store or to record given information and being formed on the substrate;
a clamp area located outside the center hole and inside the data area; and
one or more notches or grooves provided on at least one of:
a portion of the peripheral side,
another portion of the center hole, and
still another portion around the clamp area.

2. The medium of claim 1, wherein said medium is an optical disc formed of a single disc substrate.

3. The medium of claim 1, wherein said medium is an optical disc formed of double disc substrates being adhered together with a given adhesive.

4. The medium of claim 1, wherein said notch or groove is formed at a corner edge of the peripheral side.

5. The medium of claim 1, wherein said notches or grooves are formed at a corner edge of the peripheral side, such that one of the notches or grooves is located adjacent to the other of the notches or grooves.

6. The medium of claim 1, wherein one or more pairs of said notches or grooves are formed at given separated portions of a corner edge of the peripheral side.

7. The medium of claim 1, wherein said notches or grooves are formed at both corner edges of the peripheral side, such that one of the notches or grooves is located adjacent to the other of the notches or grooves, and that one of the notches or grooves is physically different from the other of the notches or grooves in order to discriminate both plane sides of the medium according to the physically-different one and the other notches or grooves.

8. The medium of claim 1, wherein said notches or grooves are formed at both corner edges of the peripheral side, such that one of the notches or grooves is located in front of the other of the notches or grooves, and that one of the notches or grooves is physically different from the other of the notches or grooves in order to discriminate both plane sides of the medium according to the physically-different one and the other notches or grooves.

9. The medium of claim 1, wherein said notch or groove contains one or more projections and/or one or more slots or openings.

10. The medium of claim 1, wherein said medium comprises a front surface and a rear surface, and said data area is provided on the front surface.

11. The medium of claim 10, wherein said data area is provided on the rear surface.

12. The medium of claim 10, wherein a label area is provided on the rear surface.

13. The medium of claim 1, wherein said medium comprises a stack ring located at the clamp area, and the stack ring is provided with one or more of said notches or grooves.

14. The medium of claim 1, wherein said one or more notches or grooves is/are configured to indicate a type, or a kind, or a medium side, or contents of the medium.

15. A disc cartridge comprising:
a case configured to enclose an information storage disc, and having two opposite sides called side A and side B;
a first mark provided on a first portion of at least one of the two opposite sides of said case, said first mark serving to identify the side A or side B of said case; and
a second mark provided on a second portion of said case, said second mark serving to indicate a type, or a kind, or contents of the disc.

16. The cartridge of claim 15, wherein the second portion for said second mark is located close to the first portion for said first mark, such that a finger of a user's hand can touch said first and second marks at a time.

17. The cartridge of claim 15, wherein the second portion for said second mark is located at a given side of the case.

18. The cartridge of claim 15, wherein said second mark comprises one or more notches, grooves, slots, or openings.

19. An apparatus for recording information recorded on an information storage medium or reading information from the medium wherein said medium comprises one or more notches or grooves configured to indicate a type, or a kind, or a medium side, or contents of the medium, said apparatus comprising:
one or more detectors configured to detect a physical figure or state of the one or more of said notches or grooves; and
a control unit connected to said one or more detectors and configured to discriminate the type, kind, medium side, or contents of the medium according to the detected physical figure or state of the one or more of said notches or grooves.

20. An apparatus for recording information recorded on an information storage disc or reading information from the disc wherein said disc is enclosed in a case having two opposite sides called side A and side B, and said case comprises a specific mark serving to indicate a type, or a kind, or a medium side, or contents of the disc, said apparatus comprising:
one or more detectors configured to detect a physical figure or state of said specific mark, and
a control unit connected to said one or more detectors and configured to discriminate the type, kind, medium side, or contents of the medium according to the detected physical figure or state of said specific mark.
